(19) United States
(12) Patent Application Publication
(10) Pub. No.: US 2009/0167958 A1
(43) Pub. Date: Jul. 2, 2009

(54) SYSTEM AND METHOD OF MOTION VECTOR ESTIMATION USING CONTENT ASSOCIATIVITY

(75) Inventor: Gordon F. Wredenhagen, Toronto (CA)

Correspondence Address: MCANDREWS HELD & MALLOY, LTD, 500 WEST MADISON STREET, SUITE 3400, CHICAGO, IL, 60661, US

(73) Assignee: ATI TECHNOLOGIES ULC, Markham (CA)

(21) Appl. No.: 11/966,095

(22) Filed: Dec. 28, 2007

(51) Int. Cl. H04N 5/14

(52) U.S. Cl. 348/699; 348/E05.062

(57) ABSTRACT

A method and apparatus that is able to favor keeping objects in motion intact is provided. Additionally a method and apparatus regularizing a motion vector field that has been previously determined by a traditional algorithm is provided. Finally, a mechanism is provided that allows for improving a contextual understanding of an object structure even when the group of pixels under consideration is much smaller than the object in motion.

### FIELD OF INVENTION

The present invention relates generally to video format processing systems.

### BACKGROUND

In video conversion, motion estimation can be used to improve conversion of motion image data by reducing the temporal redundancy in the image information. In motion estimation, a frame is selected as a reference, and subsequent frames are predicted from the reference. Traditional methods usually employ a fit-centric strategy to motion vector estimation that aims to minimize a measurement function aided by a computed motion vector.

The fit-centric approach to motion vector estimation, (e.g. block matching, or pixel-based displaced frame differencing), originated in image compression. For example, block matching algorithms are used in image compression (e.g., MPEG). By determining a best fit of a group of pixels, usually an eight by eight macro block, the entropy in the image differences is minimized and encoding the difference error then leads to efficient image compression. This motion estimation technique, which was designed for image compression, is now being applied in motion vector estimation for frame rate conversion.

A fundamental shortcoming in current motion vector estimation techniques that are based solely on fit-error is that they are not designed to consider the cost or damage to an image by removing or displacing content from its surroundings. In video conversion, it is computationally expensive to achieve absolute certainty about the direction and magnitude of inter-field motion for any given object of an arbitrary image scene. However, it is possible to compute relative degrees of certainty of apparent motion for pixel regions in the image using motion vector estimation.

Traditionally, motion vector estimation involved a process in which a group of pixels from a first image is compared to a group of pixels in a subsequent image over a search region. Once the images are compared, pixels from the first image are assigned a motion vector corresponding to a best match based on a simple pixel difference. However, this technique commonly leads to erroneous motion vector assignments, because the best match does not necessarily correspond to the direction of motion. Moreover, if the group of pixels under consideration is small relative to the size of the object in motion, parts of the object can quite readily be assigned divergent motion vectors that cause the object to appear to be broken up during temporal interpolation.

The problems with these types of prior art techniques can be illustrated with reference to FIG. 1. As shown, FIG. 1 is a diagram of two distinct regions, Region A and Region B, taken from a portion of an image. Each region has a candidate motion vector that has been computed by minimizing an error that is calculated based solely on the fit.

In FIG. 1 the motion vector MV_{A} points to a region, Region A, in a subsequent image that minimizes the fit-error in a predetermined search region. The motion vector MV_{B} is similarly determined, with the result that the pixels that minimize the fit-error come from a second region, Region B. Let J_{F}(A) and J_{F}(B) be defined as the fit error functionals for Regions A and B, respectively. Based only on minimizing the fit error, there is no reason to expect that the motion vector estimates, MV_{A} and MV_{B}, will behave in a similar manner, even if Region A and Region B contain virtually identical content. It is possible that MV_{A} and MV_{B} differ greatly. As a consequence, for content that represents a solid structure such as fence post in which Regions A and B are tangential, Regions A and B can easily be ripped apart, as shown FIG. 1.

For example, using temporal interpolation, content is moved from one image plane to the location along the direction of the motion vector associated with that pixel to a point in time that lies in between the two source frames. This process is essential to meaningful frame rate conversion because if performed properly, the effective sample rate of the input source can be increased by an arbitrary amount. The visual effect is smoother and better defined motion. However, forcibly dissociating part of the object represented by structure in image content may be disastrous when performing temporal interpolation.

A motion vector estimation procedure using a traditional fit-error approach 200 is shown in FIG. 2. In a first step 210, a video processor receives two images. The video processor selects a corresponding region in each image for comparison (step 220). The pixels from a selected region in the first image are compared with the pixels in the corresponding region in the second image, and a fit-error is generated (step 230). A motion vector is then generated based on the results of the comparison (step 240).

The amount of fit-error for a block is often measured using sum of accumulated differences (SAD) or the mean squared error (MSE), etc. However, as mentioned above, these techniques are not without their flaws. For example, SAD and similar fit-error techniques may tear apart portions of an image that represent portions of objects that should remain together. Basing a motion vector on only the minimum fit error leads to many erroneous motion vectors, because this does not account for the cost of dissociating a group of pixels in an image with neighboring pixels in the same image.

Accordingly, current motion estimation techniques have serious drawbacks. Improvements to such techniques are greatly desired.

### SUMMARY

A method of computing and regularizing motion vector estimates for frame rate conversion is disclosed. The method takes into account a factor for dissociating pixels from their surroundings during vector assignment and regularization. The method is a vast improvement on traditional motion vector estimation schemes so that the computed motion vectors result in fewer errors.

### BRIEF DESCRIPTION OF THE DRAWINGS

A more detailed understanding may be had from the following description, given by way of example and to be understood in conjunction with the accompanying drawings wherein:

FIG. 1 is a diagram of two distinct regions, Region A and Region B, taken from a portion of an image;

FIG. 2 is a flow diagram of a traditional fit-error procedure;

FIG. 3 is a flow diagram of a motion vector assignment procedure that accounts for object dissociativity;

FIG. 4 is a diagram of two distinct regions, Region A and Region B, taken from a portion of an image where Region A and region B are treated as one effective region with the introduction of the dissociativity cost;

FIG. 5 shows an image of a portion of a striped flag generated using a fit-error only approach;

FIG. 6 shows an image of a portion of a striped flag and a where a dissociativity cost was applied to the motion vector; and

FIG. 7 is a functional block diagram of a display and the video source of a video processing system.

### DETAILED DESCRIPTION

A new cost function, called the dissociativity cost, is hereby introduced to improve motion vector estimation.

Although the description refers to the use of an SAD technique for simplicity of explanation, this is by way of example only and is not intended to limit the present disclosure. Other motion vector estimation techniques may alternatively be used; they include optical flow (based on an energy minimization approach), variable size block matching, inertial models, affine and higher order models, and techniques based on phase plane correlation.

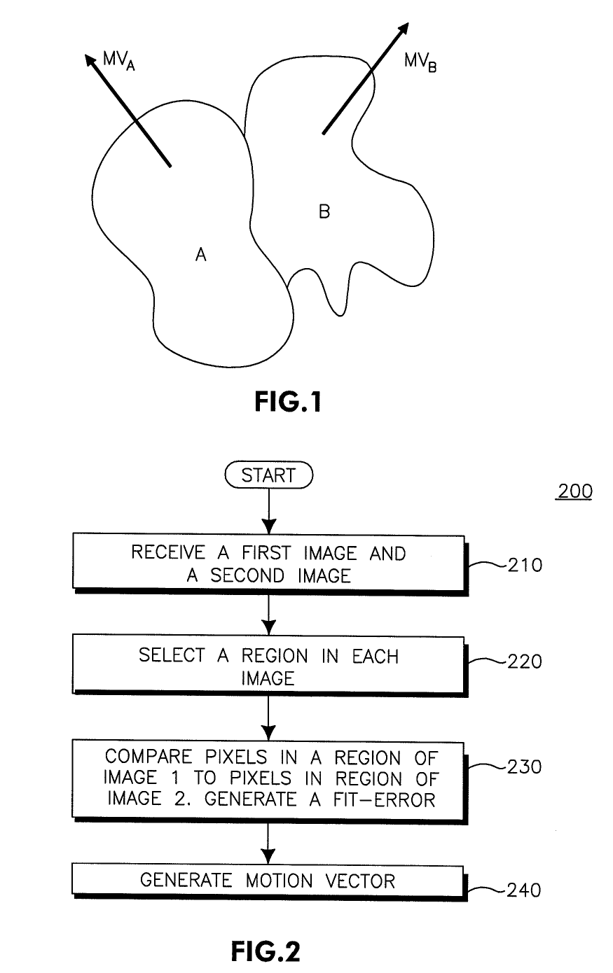

In order to repair the undesirable dissociation of objects, (which may occur when using a fit-centric approach to traditional image processing that is either agnostic or blind to objects or structures), another cost that takes into account the dissociativity cost is implemented herein. There are many possible functions that can act as a dissociativity cost, including a punitive term that weights the cost of separating Region A from Region B as shown in FIG. 1. This can be illustrated best by example below.

The dissociativity cost J_{D}(A) comprises two operative parts: 1) a weighting function ƒ; and 2) a contour integral, [symbol] . The dissociativity cost J_{D}(A) can be expressed as follows:

$${J}_{D} ( A ) = f ( {MV}_{A} , {MV}_{B} ) \times {∮}_{\partial Ω} \frac{d Ω}{{\vert ∇ I \vert}^{2} + {v}^{2}} \qquad Equation ( 1 )$$

The first part of the dissociativity cost J_{D}(A), the weighting function ƒ(MV_{A}, MV_{B}), accounts for any dissimilarity in the direction and any dissimilarity in the magnitude of the two motion vectors MV_{A} and MV_{B}. The weighting function ƒ appropriately weights the overall cost function. If the motion vectors are the same (or very similar), then the weight is zero (or close to zero).

The dissociativity cost J_{D}(A) is used to determine motion vector assignment to a pixel which may be applied once the candidate motion vectors have been determined using a traditional motion vector estimation technique. Alternatively, if PPC or another traditional motion vector estimation technique is not used to determine a set of candidate vectors, and a full-search is to be performed, then an arbitrary number of motion vectors will be generated on a real time basis and they will be tested at the same time.

If the motion vectors are substantially different, (i.e. point in opposite directions), and/or have different magnitudes, then the weight is one. If the motion vectors are substantially similar in direction and magnitude, then the weight will be zero. In general, any combination of vectors that is dissimilar in magnitude and direction will result in a weighting that is between zero and one.

With respect to the weighting function ƒ that captures the behavior of the candidate motion vectors, one (of possibly many) versions of such a function may be expressed as follows:

$$\begin{matrix}f ( {MV}_{A} , {MV}_{B} ) = max ( a , b ) ; \\ where & Equation ( 2 ) \\ a = 1 - \frac{{MV}_{A} + {MV}_{B}}{\vert {MV}_{A} \vert + \vert {MV}_{B} \vert} ; \\ and & Equation ( 3 ) \\ b = \frac{\vert {MV}_{A} \vert - \vert {MV}_{B} \vert}{max ( \vert {MV}_{A} \vert , \vert {MV}_{B} \vert ) + ɛ} . & Equation ( 4 )\end{matrix}$$

Further examining the weighting function ƒ, the function max(a, b) of Equation 2 comprises two terms, a and b, that handle two possible cases that may lead to dissociating an object. Case a handles vectors that have different directions, regardless of their respective magnitudes. Case b handles vectors that have the same, or similar, direction, but may have different magnitudes. A regularization parameter ε (included for implementation) prevents a division by zero, in the case that both vectors are zero. By taking the maximum of case a and case b, the two effects can be combined and the most significant of the two may be selected. This is one example of case a and case b. However, there are multiple ways in which motion vectors can arise to meet these requirements, the actual implementation is content specific. Other embodiments may implement different functions that can act in a similar manner, while incorporating the dissociativity cost.

The second part of the dissociativity cost J_{D}(A), the contour integral [symbol] , sums up a term that includes the gradients |∇I| in the image about a contour ∂Ω, where I is the image. The gradient number can be pre-calculated, which makes for a more efficient implementation. However, the actual order of calculations may vary depending on the application.

The contour integral [symbol] may be computed using a number of approaches. One such approach is to parse the contour ∂Ω by stepping along a path in increments in the horizontal and vertical directions, and accumulating the energy in the gradient number along the way. Once the entire contour ∂Ω is traversed, the result is a computation of the term |∇I|² in Equation (1). Adding a constant to this quantity and inverting computes the contour integral,

[symbol]

In many applications the boundary is a rectangle of predefined dimensions, this is the simplest implementation. A rectangular boundary is well defined and easy to traverse. For example, the contour ∂Ω could be the periphery of the analysis window, (i.e. the block size), used in a simple block matching scheme. Referring back to FIG. 1, the contour ∂Ω is the boundary that defines Region A or Region B.

Alternatively, the boundary can assume any shape, and in general it may be derived from another algorithm that performs an image segmentation stage. Image segmentation is a process of grouping similar regions in the image together. There are many such algorithms, see for example Watershed algorithm by Vincent, L. and Soille, P. “Watershed in digital spaces: An efficient algorithm on immersion simulations,” IEEE Trans. on PAMI (1991) 847-859. When a segmentation algorithm has segmented the image, then the contour ∂Ω is defined by a label map.

In order to collect the points that form the contour ∂Ω, a contour parsing algorithm is necessary. Table 1 shows a 16 state “state-machine” that is used to parse the boundary of an object. An object is determined from the Watershed algorithm. However, computing statistics from the results of the Watershed algorithm is still required. It is possible for each of the 2×2 tables shown in the “Pattern” column of Table 1 to be the result of a logical expression. In that way, several different types of contours can be followed in an efficient manner. The idea can be extended to an object defined in an arbitrary number of dimensions.

TABLE 1
Perimeter parsing state machine

| | | | |
|---|---|---|---|
| State | Pattern | Action | Comment |

| | | | | |
|---|---|---|---|---|
| 0 | 0 | 0 | move right | Outside object - search for |
| | 0 | 0 | | object boundary |
| 1 | 0 | 1 | move right | |
| | 0 | 0 | | |
| 2 | 1 | 0 | move up | |
| | 0 | 0 | | |
| 3 | 1 | 1 | move right | |
| | 0 | 0 | | |
| 4 | 0 | 0 | move left | |
| | 1 | 0 | | |
| 5 | 0 | 1 | move left | Ambiguous state |
| | 1 | 0 | | |
| 6 | 1 | 0 | move up | |
| | 1 | 0 | | |
| 7 | 1 | 1 | move right | |
| | 1 | 0 | | |
| 8 | 0 | 0 | move down | |
| | 0 | 1 | | |
| 9 | 0 | 1 | move down | |
| | 0 | 1 | | |
| 10 | 1 | 0 | move down | Ambiguous state |
| | 0 | 1 | | |
| 11 | 1 | 1 | move down | |
| | 0 | 1 | | |
| 12 | 0 | 0 | move left | |
| | 1 | 1 | | |
| 13 | 0 | 1 | move left | |
| | 1 | 1 | | |
| 14 | 1 | 0 | move up | |
| | 1 | 1 | | |
| 15 | 1 | 1 | move right | Inside object - move to |
| | 1 | 1 | | perimeter |

Many available algorithms, for example Green's Theorem, may be used to estimate the area of an object that is enclosed by a simply connected curve, which is a curve or set of points that do not cross over themselves. A formula for computing the area of an object (adapted to the discrete domain) is given by Equation 5:

$$Area = \frac{1}{2} {\sum }_{i = 1}^{n - 1} ( {x}_{i + 1} + {x}_{i} ) ( {y}_{i + 1} - {y}_{i} ) - ( {y}_{i + 1} + {y}_{i} ) ( {x}_{i + 1} - {x}_{i} ) \qquad Equation ( 5 )$$

Where n is the number of points, and x and y are the coordinates.

After calculating the contour integral [symbol] , its value may be weighted, using the weighting function ƒ, according to the level of dissimilarity in two adjacent motion vectors, irrespective of the image content within the region. When the weighting function ƒ is a non-zero value, then the contour integral [symbol] plays a significant role. It should be noted that depending upon the particular application a dissociativity cost, with a bias (by design) could be determined where the preference is to keep like regions together over keeping dissimilar regions apart. Such options are largely implementation driven and depend on the specific application.

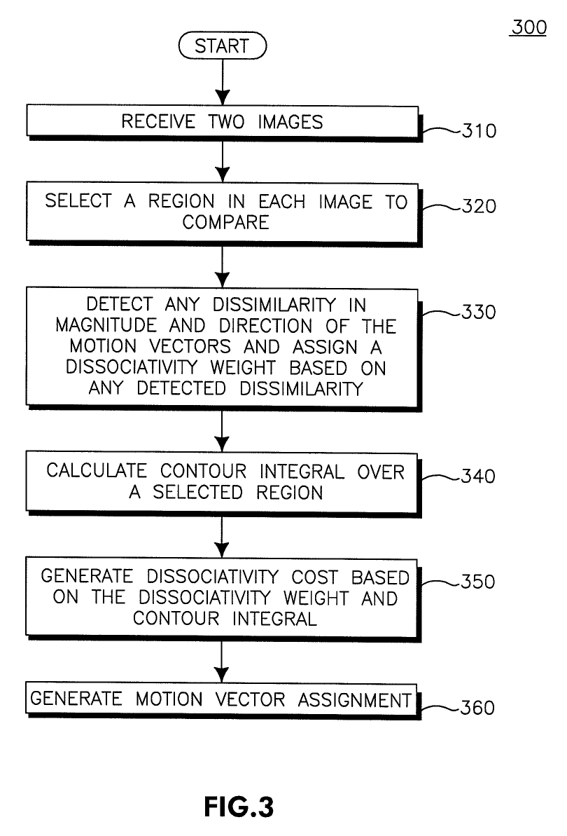

FIG. 3 shows a process 300 for generating motion vectors while also accounting for a dissociativity cost. In a first step 310, two images are received. A region within each image is selected for comparison (step 320). Any dissimilarity in the direction and/or any dissimilarity in the magnitude of the two motion vectors MV_{A} and MV_{B} are detected, and a dissociativity weight based on either or both of the dissimilarities is determined (step 330). A contour integral over the selected region is calculated (step 340). A dissociativity cost based on the dissociativity weight and the contour integral is calculated (step 350). The dissociativity cost is then combined with the motion vectors to determine the motion vector assignment (step 360).

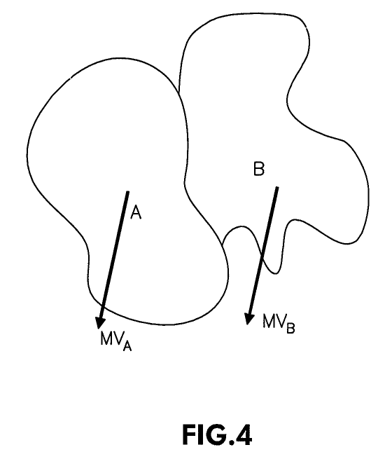

The result of this process 300 is a consistent motion vector assignment as shown in FIG. 4. By introducing the dissociativity cost the resulting motion vectors may be corrected. Based on the scenario shown in FIG. 1, FIG. 4 shows two Regions A and B in which the content is essentially the same. By considering the dissociativity cost, the total effective cost will be minimized when the motion vectors are aligned, resulting in object integrity that is faithfully maintained.

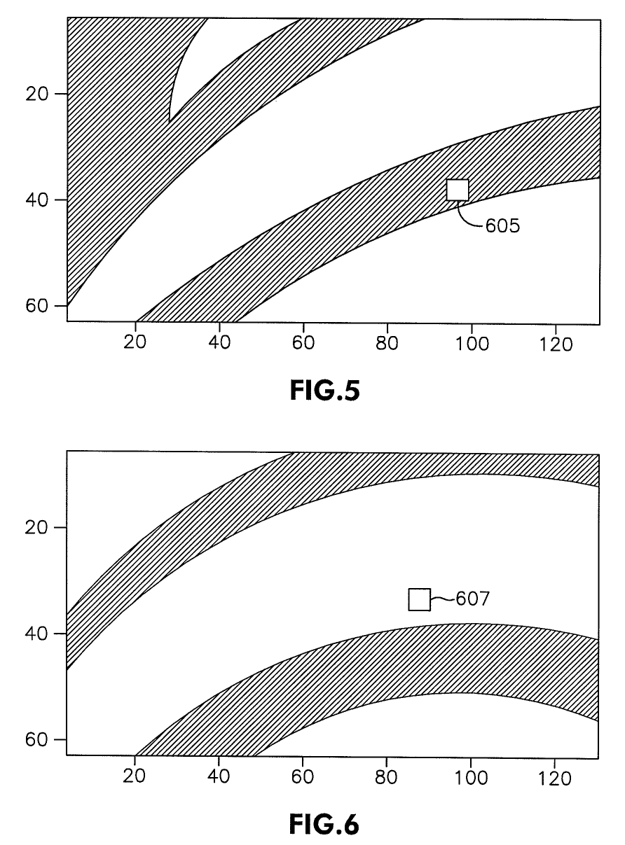

FIGS. 5 and 6 are shows two images of portions of an image of a portion of a striped flag, which will illustrate the benefits of the methods described herein. A simple minimum entropy (SAD minimization) search was performed on a small block to find the best match of a group of pixels in FIG. 5. The search was performed according to traditional methods which only account for a fit error. The block 605 was wrongly disassociated from the correct part of the flag and has resulted in an undesirable image, where a block 605 representing a white region has been misplaced onto a shaded region. In contrast, the minimum entropy result found a best match for the block 607 in FIG. 6 using the augmented cost function that includes the dissociativity cost, and thereby avoiding wrongful motion vector assignment. As a result the block 607 is properly positioned in a non-shaded region.

Depending upon the particular application to which the present methods are applied, there are other embodiments which may be utilized to optimize the methods. In a first alternative embodiment, the dissociativity cost J_{D}(A) may also include a regularization parameter ν which can avoid numerical singularities in regions where there is essentially no image gradient. Such images are those that have no textures or boundaries.

In a second alternative embodiment, this method may be applied to pixel-based matching. For example, suppose that two motion vectors point in opposite directions such that the weight for function ƒ is one. Further suppose that the region of interest is essentially flat, such that the value of the gradient is essentially zero. The overall dissociativity cost will then be directly proportional to the inverse of the square of the regularization parameter ν. So for a typically small value of the regularization parameter ν, the cost incurred in attempting the forcible dissociation of that region from its surroundings will be prohibitive, and therefore it will not be displaced from its neighboring surroundings.

In yet another alternative embodiment, in addition to the dissociativity cost, other cost techniques or functionals such as the traditional SAD may also be included. In this embodiment, for example, an augmented dissociativity cost could be formed that is a combination of both costs as follows:

J=J_{D}+J_{F} Equation (6)

where the total cost J is a combination of the dissociativity cost J_{D} and the traditional fit error J_{F}. Alternatively, many more sophisticated cost functionals could be conceived that include the dissociativity cost. It is also equally possible to weight the respective costs emphasizing one over another, or to weigh them adaptively based on other pertinent criteria such as image content. Applying adjustable weights is also possible when computing the gradients in the contour integral [symbol] .

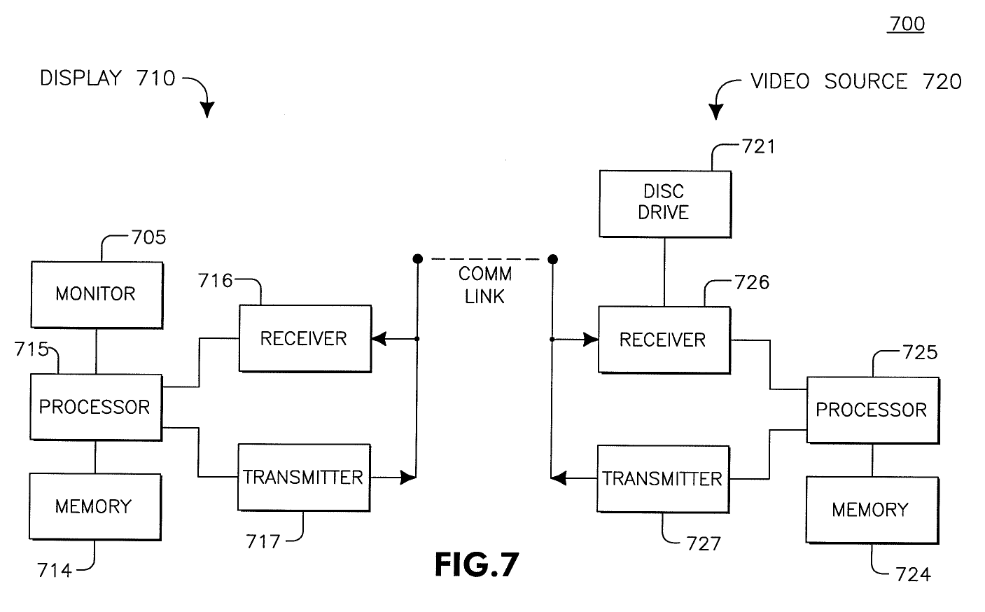

FIG. 7 shows a video processing system 700, including a display 710 and a video source 720, both configured to perform motion vector estimation. As shown in FIG. 7, the video source 720 is in communication with the display 710. The video source 720 transmits a data stream comprising images over a connection to the display 710. The data stream maybe transmitted over a physical medium (e.g. a fiber optic cable, s-video cable, coaxial cable, component based cables, etc.) or a wireless medium (satellite, WLAN, etc.). In addition to the components that may be associated with a typical display, the display 710 includes a monitor 705, a processor 715 with associated memory 714, a receiver 716 for receiving video transmissions, a transmitter 717 (optional) for transmitting video transmissions. The processor 715 is configured to perform motion vector estimation. The receiver 716 and the transmitter 717 are in communication with the processor 715. In addition to the components that may be found in a video source, the video source 720 includes a disc drive 721 (or some other type of storage medium), a processor 725 with associated memory 724, a receiver 726 for receiving video transmissions, and a transmitter 727 for transmitting video transmissions. The processor 725 is configured to perform motion vector estimation. The receiver 726 and the transmitter 727 are in communication with the processor 725.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A method of motion estimation, the method comprising:
determining a first motion estimate by comparing a first portion from a first image to a second portion from a second image;
determining a second motion estimate by comparing a third portion from said first image to a fourth portion from said second image calculating a cost element, based on said first and second motion estimates, wherein the cost element determines a cost of dissociating said first portion from said third portion; and
generating a plurality of motion vectors based on said motion estimates and the cost element.

2. The method of claim 1, wherein calculating the cost element further comprises:
calculating a contour integral of an image; and
calculating a weighting function, wherein the weighting function captures the behavior of a candidate motion vector.

3. The method of claim 1, wherein the first motion estimate is determined using block matching.

4. The method of claim 1, wherein the first motion estimate is determined using phase plane correlation.

5. The method of claim 4, wherein the contour integral is determined using a watershed algorithm.

6. The method of claim 1, further comprising:
calculating a value for a dissimilarity in direction and dissimilarity in magnitude of two motion vectors; and
calculating a cost element including the value for the dissimilarity in direction and the dissimilarity in magnitude.

7. A system for motion estimation, the system comprising:
a processor configured to determine a first motion estimate by comparing a first portion from a first image to a second portion from a second image and to determine a second motion estimate by comparing a third portion from said first image to a fourth portion from said second image calculating a cost element, based on said first and second motion estimates, wherein the cost element determines a cost of dissociating said first portion from said third portion; and
a motion vector generator to generate a plurality of motion vectors based on the second motion estimate and the cost element.

8. The system of claim 7, wherein the processor is configured to determine the first motion estimate using block matching.

9. The system of claim 7, further comprising:
a phase plane correlator configured to determine the first motion estimate using phase plane correlation.

10. The system of claim 7, wherein the processor is configured to determine the first motion estimate using optical flow.

11. The system of claim 7, wherein the processor is configured to determine the first motion estimate is based on a fit error.

12. The system of claim 11, wherein the processor is configured to determine the fit error using a sum of absolute differences calculation.

13. The system of claim 7, further comprising:
the processor configured to determine a dissimilarity in direction and determining a dissimilarity in magnitude of two motion vectors; and
the motion vector estimator configured to calculate the cost element based on the dissimilarity in direction and dissimilarity in magnitude of two motion vectors.

14. A method of motion estimation, the method comprising:
determining a first motion estimate for a first portion of an image;
determining a second motion estimate for a second portion of said image, located in proximity to said first portion;
calculating a cost element, based on said first and second motion estimates, wherein the cost element determines a cost of dissociating said first portion from said third portion; and
determining whether or not to separate said first and second portions based upon said cost element.

15. The method of claim 14, wherein calculating the cost element further comprises:
calculating a contour integral of an image; and
calculating a weighting function, wherein the weighting function captures the behavior of a candidate motion vector.

16. The method of claim 14, wherein the motion estimate is determined using block matching.

17. The method of claim 14, wherein the motion estimate is determined using phase plane correlation.

18. The method of claim 17, wherein the contour integral is determined using a watershed algorithm.

19. The method of claim 14, further comprising:
calculating a value for a dissimilarity in direction and dissimilarity in magnitude of two motion vectors; and
calculating a cost element including the value for the dissimilarity in direction and the dissimilarity in magnitude.

20. A method for generating an image using motion vectors, the method comprising:
determining a first motion estimate by comparing a first portion from a first image to a second portion from a second image;
determining a second motion estimate by comparing a third portion from said first image to a fourth portion from said second image calculating a cost element, based on said first and second motion estimates, wherein the cost element determines a cost of dissociating said first portion from said third portion;
generating a plurality of motion vectors based on said motion estimates and the cost element; and
generating at least one image using the plurality of generated motion control vectors.
